(19) United States
(12) Patent Application Publication
(10) Pub. No.: US 2016/0143797 A1
(43) Pub. Date: May 26, 2016

(54) Oscillating Hyperbaric Capsule.

(71) Applicant: Alvaro Fabian BRICIO ARZUBIDE, (US)

(72) Inventor: Alvaro Fabian BRICIO ARZUBIDE, Tlajomulco de Zuñiga, Jalilsco (MX)

(21) Appl. No.: 14/778,594

(22) PCT Filed: Mar. 21, 2013
(86) PCT No.: PCT/MX2013/000036

§ 371 Date: Sep. 20, 2015

(30) Foreign Application Priority Data
Mar. 20, 2013 (MX) MX/A/2013/003117

(51) Int. Cl. A61G 10/02

(52) U.S. Cl. CPC A61G 10/026

(57) ABSTRACT

This invention makes reference to an autonomous, versatile and non-invasive hyperbaric capsule with a new functional and esthetic design for high pressured air or oxygen therapies for one or more people which can be installed vertically to a structure. It has an oscillating effect starting the vertical until the horizontal and features a new bolted gate with a twin closure mechanism of 2 movements and 3 positions. Also, it has all the necessary equipment already built in ready to be operated to the pleasures of the patient inside or by an assistant in the outside.

### INVENTION'S FIELD

The following invention refers to pressurized chambers or capsules used in hyperbaric oxygenation therapies for human beings by exposing them to hyperbaric conditions in a fixed amount of time. The referred capsule creates a pressured environment above normobaric conditions where oxygen enriched air is breathed by the patient. This therapy is named hyperbaric oxygenation (HBOT) and it's used to treat a wide range of medical and physiological conditions.

### BACKGROUND

The hyperbaric oxygenation therapy (HBOT) is a medical procedure approved by the FDA (Federal Drug Administration, USA) where a patient is set inside a pressurized (hyperbaric) chamber and it's exposed to breath air with a 21 to 100 percent of oxygen concentration. According to the FDA, this therapy is prescribed for medical conditions such as decompression sickness in divers, pressure ulcer, radiation necrosis, acute carbon monoxide poisoning, acute gas embolism, gas gangrene, refractory osteomyelitis, acute traumatic ischemia, acute cyanide intoxication and acute cerebral edema, among others. Furthermore, there are many medical reports showing the positive results of this therapy applied in patients suffering from critical conditions such as thermal burns, bone grafts, acute poisoning by carbon tetrachloride, fracture healing, multiple sclerosis, sickle-cell disease, autism and numerous other conditions.

Some of the benefits of the HBOT include: Increasing oxygen concentration in all body tissues, stimulation of new blood vessels in places with poor blood circulation, improvement of blood flow to areas with arterial blockage; It also causes a rebound in arterial dilation at the end of the therapy resulting in an increase in diameter of the blood vessels, this leads to an improvement of blood flow to the organs of the entire body (perfusion), stimulus of superoxide dismutase (SOD) production, a major antioxidant and free radical scavengers (internally produced by the body). It also helps in the treatment of body infections by improving the performance of white blood cells among many others positive physiological mechanism for the human body.

Traditionally a hyperbaric chamber is cylindrical shaped, equipped with a rounded door in one of its side ends in which the patient can access in upright position or laid down its back. It is placed in a large room due to its big size and there is a small hatch where patients access the chamber, this design seems to be dictated by the necessity of minimizing the hatch (door) area in order to minimize the force applied to it when the chamber is pressurized. The traditional hyperbaric chamber must be placed in a large room (even larger if the entry position for the patient is in the upright position), this requirements are valid not only to accommodate the chamber but also to accommodate the rest of the equipment required for its operation. In these cases, owners need to save a large area or room in their facilities to accommodate the chamber, reducing the possibilities for small hospitals or clinics to install one, because of its high cost and space required.

The inconveniences mentioned before, added to the high cost of hyperbaric oxygenation therapy in clinics and hospitals, have limited the therapy's range of treatment to only a few that have use them for medical conditions (where effectiveness of hyperbaric oxygen therapy has been proven successful) and they have limited the reach of studies in other medical conditions that may have a potential benefit to health.

Since its common practice that patients get HBOT daily, during one or more weeks from one to two hours, for many this represents a major challenge, not only because of the therapy's high cost, but also because of transportation expenses resulting from getting to one of these facilities that are located in hospitals and clinics not always near the patients' house.

Several patents have been submitted for hyperbaric chambers, these are made of rigid materials and soft materials like steel and plasticized fibers cloths correspondingly. Other characteristics that these chambers display are their spacious size or “required to be assembled” design. Nowadays there are no hyperbaric chambers made of soft materials that achieve the possibility to get an inside pressure above 1.3 ATA and there is no hyperbaric chamber made of rigid materials designed to support 3.0 ATA or more, with a mechanism that allows to oscillate the chamber from vertical to horizontal position, be compact enough to be installed in a small clinic or at home and to be operated either by the technician, the user and/or a remote 3^{rd} party.

U.S. Pat. No. 5,327,904 by Hannum James E and also U.S. Pat. No. 7,556,040 B2 by Allan Dolph Meyer, Norman Michael Berry and James Martin Davidson show a rigid material hyperbaric chamber with its entrance designed to insert the patient backwards on a sitting position. It allows no possibility of being reclined in any angle. Furthermore, none of the gate designs in these patents show a bolted door.

A similar situation occurs with U.S. Pat. No. 5,398,678 granted to Rusten and Gamow in which they present a chamber that is made of soft materials, here the time required to assemble the hyperbaric chamber and set it up for a therapy's session is very long and inconvenient. In addition, this version of the chamber is too big and a hinder to be installed in a regular size room. (Due to its composition, this type of soft material chambers offers limited benefits for the hyperbaric oxygenation therapy being that it is only possible to pressurize them partially of the levels required.)

Another patent in a similar situation is the No. 2008/0006272 A1 to Peter A. Lewis; this model of folding chamber is made of soft materials and lacks a rigid bolted gate, it does not offer any possibility of inclination for the patient. Additionally, the U.S. Pat. No. 6,352,078 for David E. Harvey and Charles Wright features a closing mechanism, but in this design the gate lacks rebar bolts inserted in the internal face of the chamber's entry border and there is practically no movement that allows the pressurized air to be working to seal the seal of the gate through the displacement of it towards the internal face of the chamber's access.

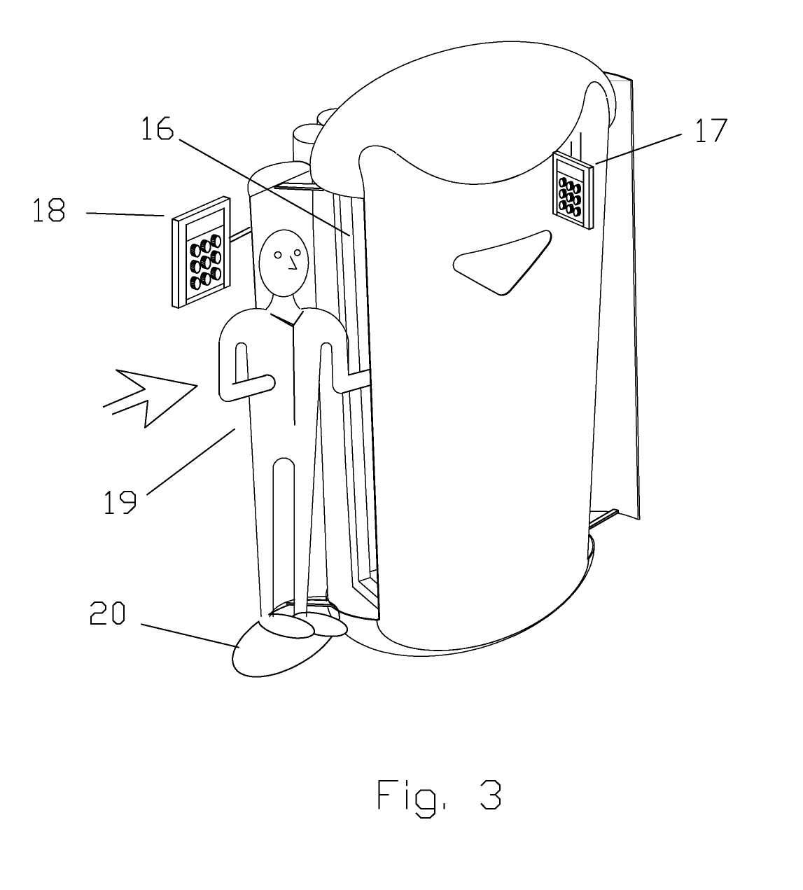

In FIGS. 3A, 3B, 3C, 5, and 9 of this patent it's not clear how the external surface of the gate No. 62b moves against the internal surface of the chamber No. 26b because of the end of the bolt No. 98 or because of the air pressure, the gate's movement in this direction is blocked at all times by the lower track of the gate No. 138.

The presenting invention proposes that the HBOT should be accessible to many people because of the next reasons:
1.—Solid Materials, this capsule can endure several times the atmospheric pressure.
2.—Oscillating Mechanism, this invention solves the space problem that is needed to install and operate this type of machines; it can be placed anywhere without compromising big spaces.
3.—Resources and time savings for the patients because by having it handy they have the possibility of holding therapies as frequently and for as long as they wish to (always under a medical regime).
4.—It offers the possibility of starting a HBOT immediately without any assembly of parts in contrast to hyperbaric chambers made of soft materials.
5.—The oscillating mechanism allows the patient to choose positions starting in any degree between the vertical and the horizontal, including inverted positions.

### DESCRIPTION OF THE INVENTION

This patent application introduces a functional and esthetical design for the hyperbaric capsule. It features a new oscillating mechanism assembled on its back, a new bolted side gates design with twin closure mechanisms placed in the upper and lower parts of the capsule that will empower the patient to open and close the bolted gate easily on a reduced space providing a convenient access to the capsule through either one of its two side-doors.

This hyperbaric capsule, with all of the features listed above, resolves many of the troubles the patient has to go through due to the following reasons:

One.—The oscillating mechanism achieves a non-invasive fully integrated solid material capsule, capable of enduring several times the atmospheric pressure.

Two.—The control of the capsule is operated from either inside, outside or remotely.

Three.—The bolted gates come in an innovative twin closure mechanism (located in the upper and lower side) featuring a 2 movements and 3 positions gate operation. This ensures a hermetic seal even on a reduced space. This gear helps maintain the mechanical integrity of the capsule when the pressure rises.

Four.—Due to its oscillating mechanism, the patients can be placed in positions starting the vertical line and all its range to the horizontal line, besides the position can be inverted in any degree. This last characteristic is very important when the high blood flow to the brain is needed in HBOT.

Five.—It is compact and fully integrated because all the hydraulic, pneumatic, and electric controls that are necessary to operate the capsule, as well as the required equipment to energize the oscillating mechanism, are installed in the upper, lower or back side of the capsule.

Six.—The capsule's design can be scaled in order to increase its capability to more than one person at the same time.

Seven.—The entrance and the exit are made through one of the two lateral gates. This is a security feature that reduces the possibilities of an accident due to the malfunctioning in the opening of the bolted gates.

The capsule is made in its entirety with resistant materials such as steel, stainless, titanium or aluminum. The machines that are used to produce the dimensional conformation of the pieces are presses, benders, and milling machines, electric welding joints or high strength steel fasteners are used to assemble so it can exceed the international standards for this type of equipment. Once completed, it supports the required resistance to: Endure several times the atmospheric pressure inside of the capsule, operate the oscillating mechanism and guide the movement of the capsule from vertical to horizontal (and vice versa).

A normal therapy begins with the capsule in an upright position and both exterior doors opened. In order to allow the access of the users, the bolted doors will remain open as well, then the patient has to climb the built in platform that is included for this sole purpose. The next step for the patient will be to close the bolted gates (which can be manually operated) and increase the interior pressure of the capsule with the entry of regulated pressurized air, which will help to the hermetic closure of the doors. Then, the inclination of the capsule will be operated and the patient can now enjoy the hyperbaric therapy. When the session's time has ended, or the patient wishes to leave the capsule, an exit routine returns the capsule pressure back to the atmospheric pressure and the position to a vertical one. Once the internal pressure is the same as the one in the exterior, the bolted gates are easily opened and the patient can exit.

Having explained the nature of the present invention, this text will now continue with examples in reference to the attached drawings in where it's shown the twin closure mechanism manually actuated as well as with force cylinders. The experts in the technique will perceive that many variations and modifications can be devised without drawing away of the scope of the invention as previously described.

### EXAMPLE 1

Oscillating hyperbaric capsule made with solid materials; its bolted gates are operated by a twin closure mechanism of 2 movements and 3 positions, either manually triggered or with force cylinders.

Attached Drawings:

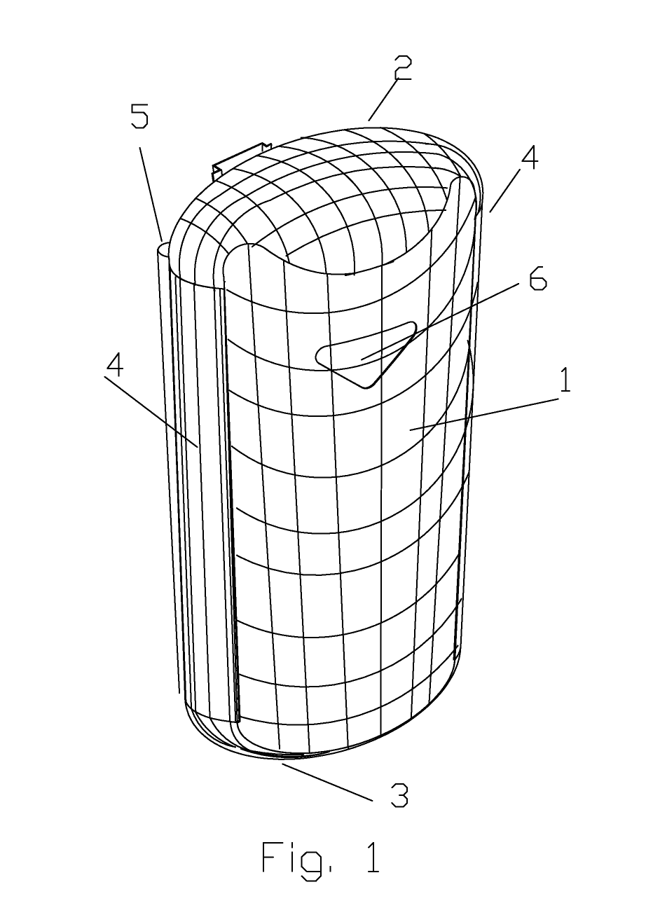

FIG. 1: Exterior view of the capsule with its gates closed.

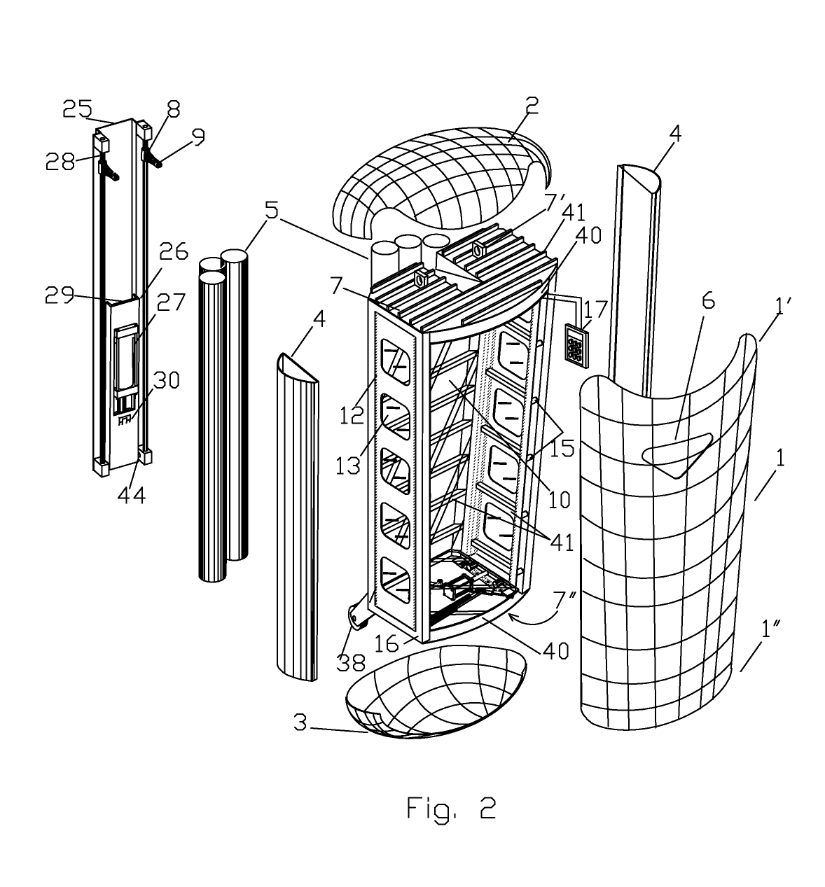

FIG. 2: Exterior view (exploded) of the capsule.

FIG. 3: Exterior view of the capsule with the patient entering inside.

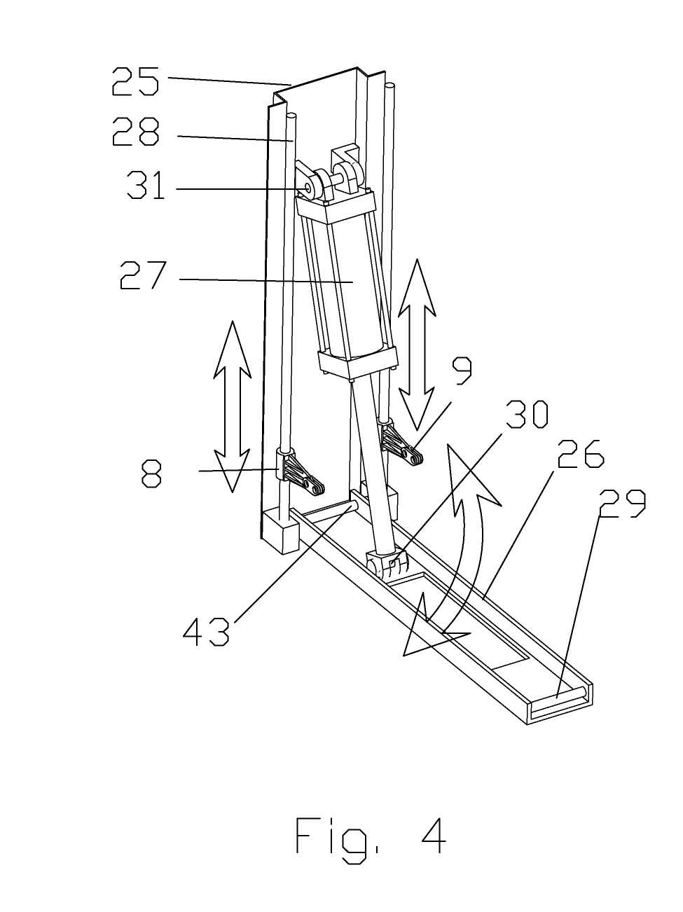

FIG. 4: View of the oscillating mechanism (the capsule has been removed).

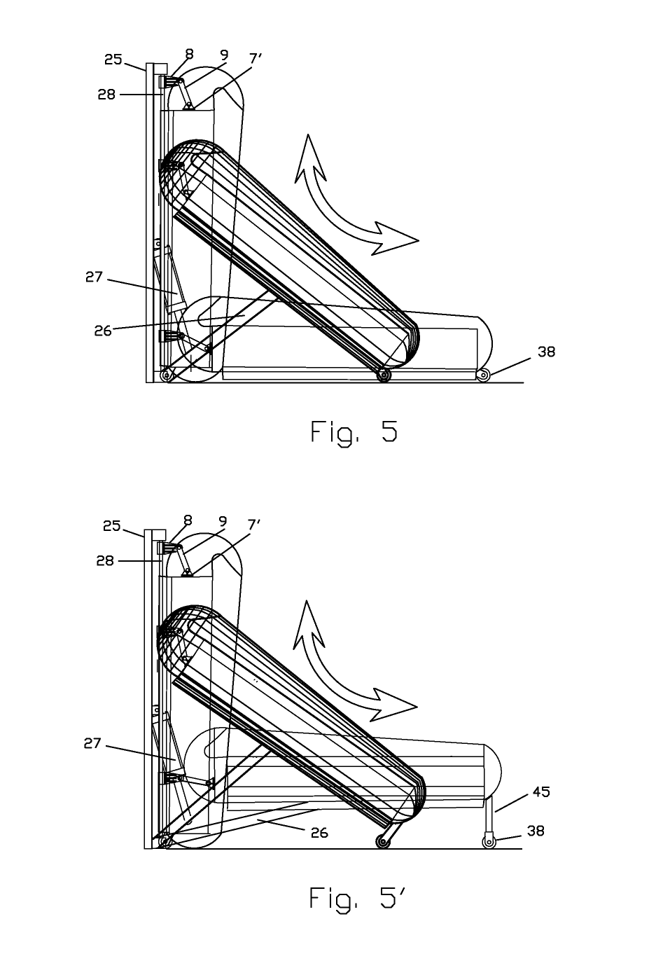

FIG. 5: Side view of the oscillating mechanism with the capsule attached to it. The drawing shows an upright, leaning and horizontal position.

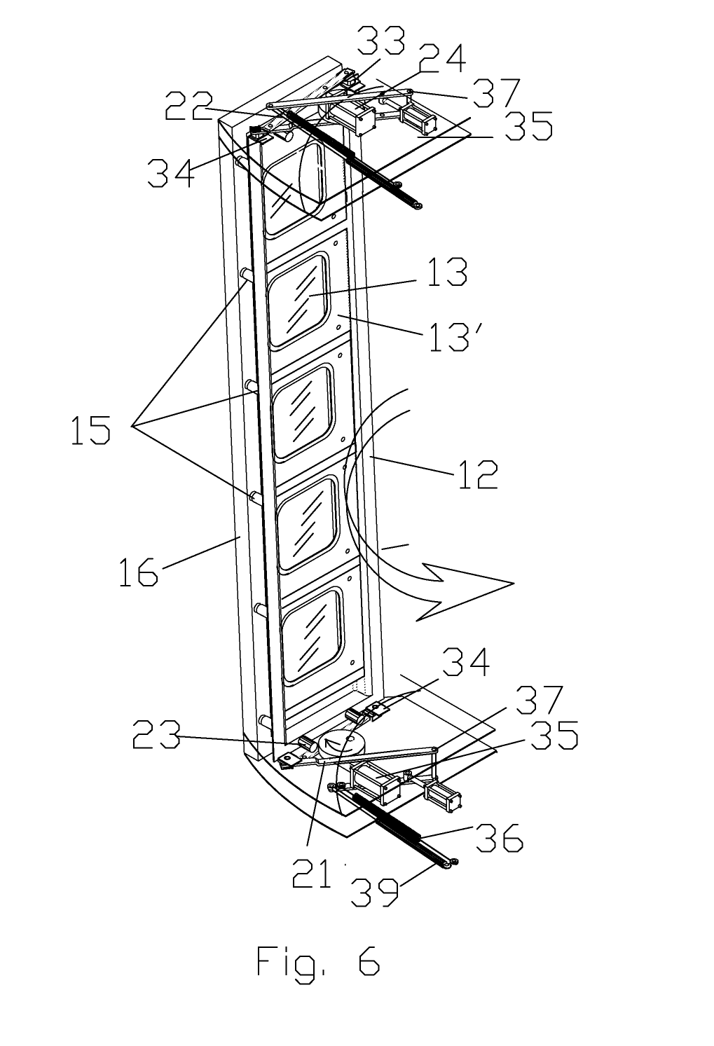

FIG. 6: Interior view of the bolted gate and the twin closure mechanism.

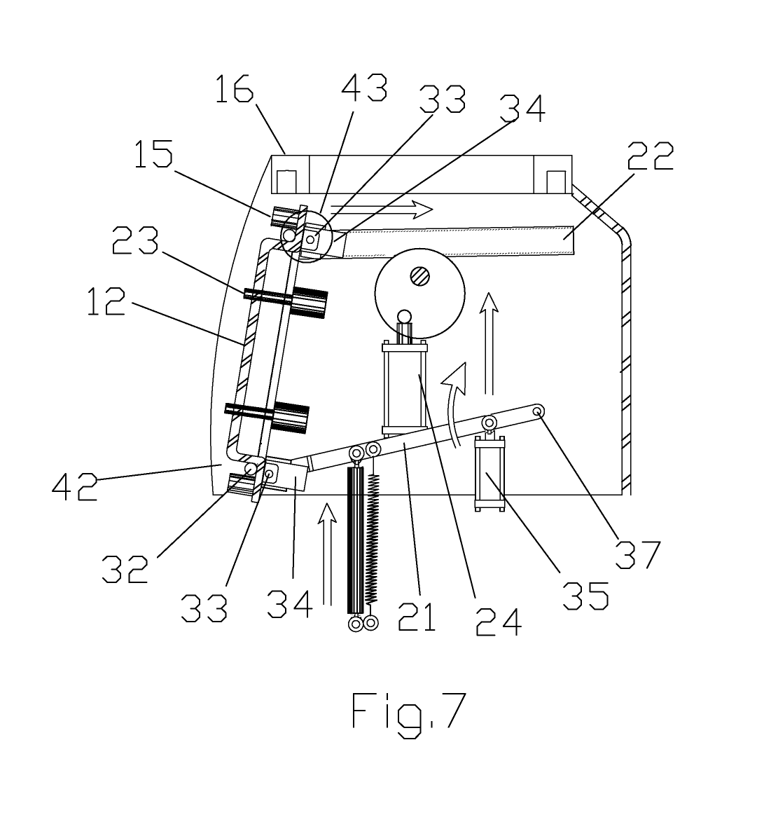

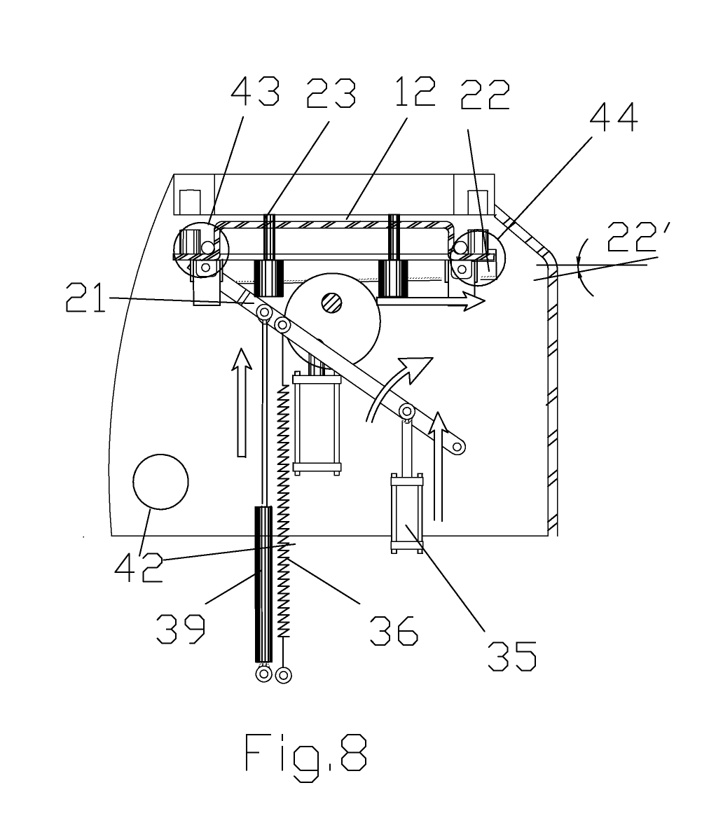

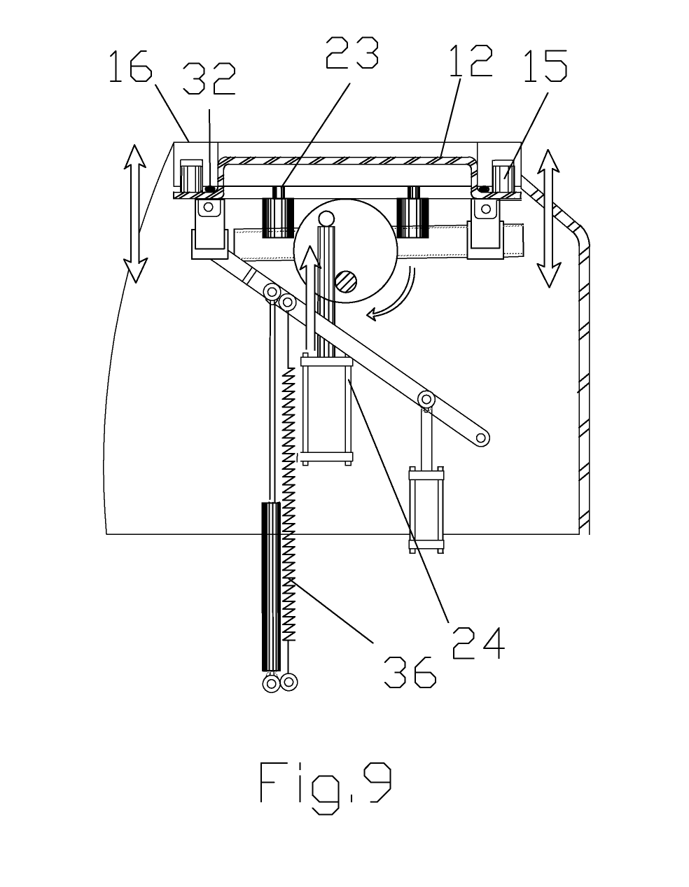

FIGS. 7, 8 and 9: Example of the manual driving of the closure mechanism of 2 movements (rotation and translation) and 3 positions of the interior bolted gate. FIG. 7.—Open Position, FIG. 8.—Pre-Closed Position, FIG. 9 Closed Position.

FIG. 1 shows an example of the invention.

FIG. 2 shows a full exploded diagram of the invention which models: the cover of the capsule #1, the upper cover #2, the lower cover #3, two exterior doors #4, interior bolted gates #12, two access frames #16, an upper plate #7, a lower plate #7, and a base #10, structural reinforcements #41 are installed as backing, two vertically displaced carriage bearings #8, for the alignment and two links #9 are connected to the capsule in the plate #7 forming a hinge; the last #3 pieces are part of the oscillating mechanism of the capsule.

An arm of the oscillating mechanism #26 of the capsule is actuated by force cylinders #27 hinged together with the bearing link #30, the arm of the oscillating mechanism is coupled to the base #10 of the capsule by a bolt bearing #29. The upper and bottom cover #3 are removable for easy access. The hydraulic, pneumatic, electric and electronic components used in the operation of the capsule are stored in both compartments of the capsule and on the rear frame. A mechanical system with two wheels #38 that operate in conjunction with the arm #26 slide the capsule from vertical to horizontal and allows it to position it at a convenient height above the floor.

The upper and lower plates of the capsule #7, #7″ are reinforced on its outer face with a series of rectangular shapes #41 of durable material that prevents deformation of the plates when the capsule is pressurized. The bolted gate of the capsule #12 and the lower twin locking mechanism are shown in this figure. Two double-walled compartments #40 at the top and bottom of the capsule house the twin closing mechanisms, which function simultaneously when opening or closing the inner bolted gate #12. This twin closing mechanism is detailed in FIGS. 7, 8 and 9.

In FIG. 3, patients #19 enter into the capsule through the gate frame #11 accessing laterally, i.e. through the right or left side; a folding step #20 helps the patient in this movement. The capsule is controlled by either the control panel #17 that is installed inside at the upper side or the one outside the capsule #18, which and can also be controlled in a remote location with internet access.

FIG. 4. In this view, wherein the capsule has been removed, the innovative oscillating mechanism of the capsule is shown, the oscillating arm mechanism Capsule #26 is driven in a movement up and down by cylinders force #27 which are hinged together at the junction of bearing #30, the other end of the cylinder is supported to the frame #25 through the bearing pin #31, the arm oscillating mechanism #26 is coupled to the base #10 capsule packed bolt #29. Two carts axial sliding bearing #8 are attached to the top plate of the capsule body through two links #9 # coupled supports 7′ of the upper plate shown in FIG. 2, being promoted arm #26 pushes the capsule in the same direction, axial displacement carriages bearing #8 mounted on the two vertical bars #28 accompany the capsule on its way from its vertical to its horizontal position, with two arms operating wheel #38 together with the slide arm #26 and let you position it at a convenient height above the floor.

FIG. 5 shows three positions for the hyperbaric capsule (vertical, inclined and horizontal), created to efficiently achieve the tilting movement of the capsule. This new mechanism peaks on the vertical position by standing in the rear base of the capsule #10 and occupies a much reduced space, as seen in previous figures.

FIG. 6 represents the new twin locking mechanism for the interior bolted gate #12, which is housed in the double wall upper and bottom compartments #40, also, figure #13 shows the side windows of the capsule which are made of transparent material and the steel frame that holds them #13′. When the gate is set at position 3 (Closed) several hardened bolts #15, placed on the front of the inner gate #12, penetrate the gate's frame of the capsule #16, when pressured, these work developing a shear reaction against any deformation of the capsule.

FIGS. 7, 8 and 9 details a diagram of the twin bolted mechanism.

The opening and closing movement of the inner gate is achieved by two similar sets of lock mechanisms located in each of the double-walled capsules #40; one at the top and one at bottom. The purpose of this new mechanism is to seize the high pressure inside the capsule to produce a hermetic seal against the frame of the gate #16 avoiding that it suffers any deformation when the capsule is being pressured and the gate #12 fully closes, thus reinforcing the structure of the frame of the gate #16 due to the cutting resistance force delivered by some hardened bolts #15 installed in the front face of the interior gate #12 that enter the frame of the gate #16.

The basic parts of the twin locking mechanism are: A pivot arm #21, a long bearing slider #22, a short bearing slider #34 and a plain bearing swivel. #33

This mechanism may be supplemented with other components for its automation such as: A power cylinder #35, a power cylinder with cam #24, a buffer #39, and an opening spring. #36

This mechanism is intended to achieve different positions for the internal bolted gate #12 from its opened position to its closed position through a movement in pivoted arc in point #37 of the end of the gate and the linear sliding on the other end of the bearing bar #22, thus placing it on a parallel position to the interior face of the capsule gate's frame #16. This arc movement helps achieve the maximum opening of the gates, getting as close as possible to the interior face of the covering #1 during the opening or closing routing with the purpose of maximizing the free space in the interior of the capsule.

The operation is as follows:

In FIG. 7 the four corners of the capsule's inner bolted gate #12 are mounted on a short slider bearing #34 and, at the same time, in a turntable bearing #33, also the two corners near the covering #1 are mounted at the end of the arms (upper and lower) of the locking mechanism #21, which pivots on the other end on a bolt and taper bearing #37. The other two corners of the internal bolted gate #12 will be assembled in the long scroll bar bearing #22 which will have a degree of opening #22′ with respect to the internal face of the frame of the capsule's gate #16 to ease the closing motion.

In FIG. 8 by manually pushing the gate #12 (or by the action of cylinder #35) the arm of the mechanism #21 will move, in a circular path, two corners of the inner bolted gate #12 taking it from its opening position #42 to its pre-closed position #43, also the other two corners of internal bolted gate #12 will slide from its open position #43 to its pre-closed position #44. The clamping force of the user over the gate or the two springs #23 keeps a gap between the inner bolted gate #12 and the frame of the capsule's gate #16 allowing air-flow into the capsule.

In FIG. 9 the internal bolted gate #12 will move against the frame of the capsule's gate #16 when it is pushed by the user or when the cam of the cylinder #24 is actuated. The seal #32 will compress between the internal bolted gate #12 and the internal face of the frame of the capsule's gate #16 thus creating an airtight seal. At the same time, the bolts of the internal gate will penetrate the frame of the gate #16 while enabling deform under the force of internal pressure of the capsule (a buffer #39 that can be calibrated will help structure the closing mechanisms to work in a gentle way).

The opening of the inner bolted gate will follow the same path in reverse.

Finally it is worth mentioning that the compact design of this invention has been obtained by the functional analysis and the structural strength of each of its rigid parts, which was achieved to be done in an efficient way. Additionally, the role that each party plays in the mechanism also contributes in the final structural strength, i.e. the design of the arrangement of all the parts mentioned in this invention has efficiently obtained an excellent functional design and an excellent structural capacity with high mechanical strength, as we have stated, its inside will endure several times the atmospheric pressure.

Having described adequately my invention, I consider it as an innovation and therefore I claim as my sole property the content of the following clause:

1. Hyperbaric capsule made of solid materials that characterizes for having a design that allows more than one user and that its composition includes a capsule body, an structural metallic profile located on the back side of the capsule allowing this to be installed in any wall or vertical structure, the structural metallic profile also houses an oscillating mechanism that enables it to oscillate from vertical to horizontal position, the capsule also has one pair of exterior access doors located on each lateral side of the capsule, one pair of internal bolted gates on each lateral side of the capsule which perform an hermetic seal on the body of the capsule and that are triggered through 2 twins mechanisms of closure located on the upper and lower back side of the capsule, this provides the characteristic of being operated in 2 movements and 3 positions. It include internal, external and remote control panels.
